(19) United States
(12) Patent Application Publication
(10) Pub. No.: US 2011/0107654 A1
(43) Pub. Date: May 12, 2011

(54) Coaster Device for Protecting Furniture from Crawling Insects

(76) Inventor: Leon R. Wieler, Winnipeg (CA)

(21) Appl. No.: 12/944,989

(22) Filed: Nov. 12, 2010

Related U.S. Application Data
(60) Provisional application No. 61/260,493, filed on Nov. 12, 2009.

(51) Int. Cl. A01M 1/20; A47B 91/12; A01M 1/24

(52) U.S. Cl. 43/131; 248/346.11; 43/132.1; 43/123

(57) ABSTRACT

A bedbug protective coaster device supports a furniture leg of an article of furniture thereon. The device includes a body comprising a base member, a first annular wall and a second annular wall formed integrally with one another such that the furniture leg can be supported on a central area of the base member. The first and second annular walls surround the central area to define an annular space between the walls arranged to contain an insect barrier fluid therein. The integral body further includes an annular crevice formed in the body so as to surround the second annular wall. The annular crevice is arranged to receive a pesticide rated only for cracks and crevices therein. The device thus allows bedbug pesticides rated for cracks and crevices to be used in a barrier location between the floor and an article of furniture such as a bed.

This application claims the benefit under 35 U.S.C. 119(e) of U.S. provisional application Ser. No. 61/260,493, filed Nov. 12, 2009.

### FIELD OF THE INVENTION

The present invention relates to a coaster device arranged to be supported on the floor to support a leg of an article of furniture thereon for protecting the furniture, for example a bed, from access by crawling insects, for example bedbugs.

### BACKGROUND

Bed bugs are attracted to places where people sleep, namely beds. For obvious reasons it is illegal to treat a bed with residual pesticides and without a residual pesticide it is very difficult to kill the bugs in the bed. This fact often causes people to discard infested beds. A bed can, however, be successfully treated by heating it in a chamber to a minimum of 122 degrees Fahrenheit which is known to kill all stages of bed bugs.

Bed bugs are also known to harbour in areas surrounding the bed such as baseboards and furniture. If one sterilizes a bed the bugs in the baseboards and furniture will simply reinfest the bed.

Traps and various protective coaster devices are known to be used for preventing access by bed bugs onto a bed by preventing access of the bed bugs to the legs of the bed. Pit fall traps are currently in use but often fail because tenants interfere with the device or debris builds in them allowing escape. The manufacturer acknowledges these shortcomings stating they are not intended as traps—rather they are monitoring devices. Pit fall traps can also accumulate large numbers of healthy bed bugs causing challenges for appropriate disposal. There is also the potential that the Bed bugs, caught in an open setting, may become alarmed during the normal course of a day causing alarm pheromones to be released dissuading other bugs from entering the trap. Glue boards trap bed bugs as well but it is well known that bed bugs can walk across several inches of new glue board before being caught making them far from fool proof. Or they may simply be repelled by the initial stickiness of the board. Or the glue boards attract lint and dust making them even less effective.

One device that works very well is a moat of water or mineral oil. Bed bugs will not cross a pit of water or mineral oil and this barrier is not easily compromised by dust or debris. In fact a 1 inch deep layer of mineral oil will remain functional for several months. The difficulty with this device is that the bugs will avoid the mineral oil and continue to infest the surrounding areas—often climbing other nearby structures such as night stands and dressers in their quest to be closer to the carbon dioxide source. If a food source is excluded long enough there is a possibility that the bugs would migrate to a different food source.

Some examples of traps and protective coasters are described in the following U.S. Pat. Nos. 223,321 by Denton; 427,143 by bauchmuller; 559,414 by Smith; 898,852 bu Duggan; 1,581,410 by Welsh; and 6,505,433 by Roberts.

Some prior art devices rely on pesticides, however bed bugs are gaining resistance to many pesticides on label for bed bugs and will not die without repeated contact with the pesticide. There are a few “on label” pesticides such as pyrethroid dusts that are on label for bed bugs in the United States that are effective against even resistant bugs but these pesticides can only be used in cracks and crevices and therefore illegal for use on beds or other known coaster devices. Canada is currently investigating the legalization of these pyrethroid dusts for bed bugs as well.

### SUMMARY OF THE INVENTION

This invention takes advantage of many of the above stated facts and avoids many potential problems of existing traps. The protective device according to the present invention is typically used in conjunction with a heat sterilized bed and is ideal for the extermination of bed bugs.

According to one aspect of the invention there is provided a protective coaster device for supporting a furniture leg of an article of furniture thereon, the device comprising:

a body comprising a base member, a first annular wall and a second annular wall formed integrally with one another;

the base member being arranged to be supported on a floor and support the furniture leg at a central area thereon;

the first annular wall being joined to the base member so as to surround the central area of the base member and to extend upwardly from the base member to an upper peripheral rim surrounding a central opening arranged to receive the furniture leg therethrough;

the second annular wall being joined to the base member so as to surround the first annular wall and to extend upwardly from the base member to an upper peripheral rim;

the second annular wall being spaced outwardly from the first annular wall to define an annular space having an open top end between the first and second annular walls arranged to contain an insect barrier fluid therein; and

the integral body further comprising an annular crevice formed therein so as to surround the second annular wall, the annular crevice being arranged to receive a pesticide for cracks and crevices therein.

Preferably a pesticide rated for cracks and crevices is provided in the annular crevice and an insect barrier fluid, for example water or mineral oil which prevent passage of bedbugs, is provided in the annular space between the first and second annular walls.

By providing a protective device with an annular crevices therein, more effective pesticides rated only for use in cracks or crevices can be incorporated as a barrier which crawling insects, for example bed bugs must cross to reach the furniture legs of a beg for example. By combining the crevice about a first annular space with a liquid barrier therein, the insects are first exposed to the pesticide as they attempt to reach the bed, and once exposed to the pesticide they are prevented access to the bed. Accordingly people sleeping in the bed are effectively used as bait to attract the insects to cross the pesticide in the crevice of the coaster device in a more effective manner than traditional locations for pesticides rated for cracks and crevices such as baseboards and the like. The relationship of the annular crevices of pesticide surrounding the annular space with a liquid barrier therein also results in the insects crossing the pesticide barrier a second time once they encounter the liquid barrier and must return back across the pesticide to return to the surrounding environment. The insects are thus more readily exposed to the pesticide to ensure extermination thereof.

Preferably the annular crevice is arranged to receive a pesticide rated for cracks and crevices in accordance with pesticide labelling and as defined by pesticide regulatory bodies.

The annular crevice may be vertically oriented between the base member and a top opening such that the crevice is elongate in a vertical direction in cross section between the base member and a top opening.

An inner surface of the annular crevice may be formed of a material having a high coefficient of friction so as to be arranged to allow climbing insects to readily climb thereon.

When the annular crevice extends downwardly from a top opening, the top opening preferably has a radial dimension which does not allow access by pets and children, for example the opening may be less than ½ an inch.

When the body comprises a third annular wall joined to the base member so as to surround the second annular wall and to extend upwardly from the base member to an upper peripheral rim, the annular crevice is preferably defined between the second and third annular walls.

Preferably the second annular wall is taller in height from the base member than the third annular wall. The height of the second and third annular walls from the base member in the illustrated embodiment is greater than 3 inches, for example approximately 4 inches.

The first, second and third annular walls may be generally cylindrical in shape and concentric with one another. The first annular wall is preferably shorter than the second and third annular walls. In the illustrated embodiment, the second and third annular walls are approximately twice a height of the first annular wall.

According to a further aspect of the present invention there is provided a method of isolating an article of furniture comprising a plurality of furniture legs from crawling insects, the method comprising:

providing a protective coaster device associated with each furniture leg, each protective coaster device comprising:
a body comprising a base member, a first annular wall and a second annular wall formed integrally with one another;
the first annular wall being joined to the base member so as to surround a central area of the base member and to extend upwardly from the base member to an upper peripheral rim surrounding a central opening arranged to receive the furniture leg therethrough;
the second annular wall being joined to the base member so as to surround the first annular wall and to extend upwardly from the base member to an upper peripheral rim;
the second annular wall being spaced outwardly from the first annular wall to define an annular space having an open top end between the first and second annular walls; and
the integral body further comprising an annular crevice formed therein so as to surround the second annular wall;

supporting the base member of each coaster device on the floor and supporting the associated furniture leg at the central area on the base member;

providing an insect barrier fluid in the annular space of each coaster device between the first and second annular walls; and

providing a pesticide rated for cracks and crevices in the annular crevice surrounding the second annular wall of each coaster device.

The method may further comprise providing each coaster device with a third annular wall joined to the base member so as to surround the second annular wall and so as to extend upwardly from the base member to an upper peripheral rim such that the annular crevice is defined between the second and third annular walls.

The method may further include supporting both the second and third annular walls of each coaster device in a vertical orientation having a substantially identical height such that the annular crevices are elongate in a vertical direction between the base member and the open top end of the annular crevice.

One embodiment of the invention will now be described in conjunction with the accompanying drawings in which:

### BRIEF DESCRIPTION OF THE DRAWINGS

FIG. 1 is a perspective view of an article of furniture supported on a plurality of protective coaster devices.

FIG. 2 is a top plan view of one of the protective coaster devices according to FIG. 1.

FIG. 3 is a sectional elevational view along the line 3-3 of FIG. 2.

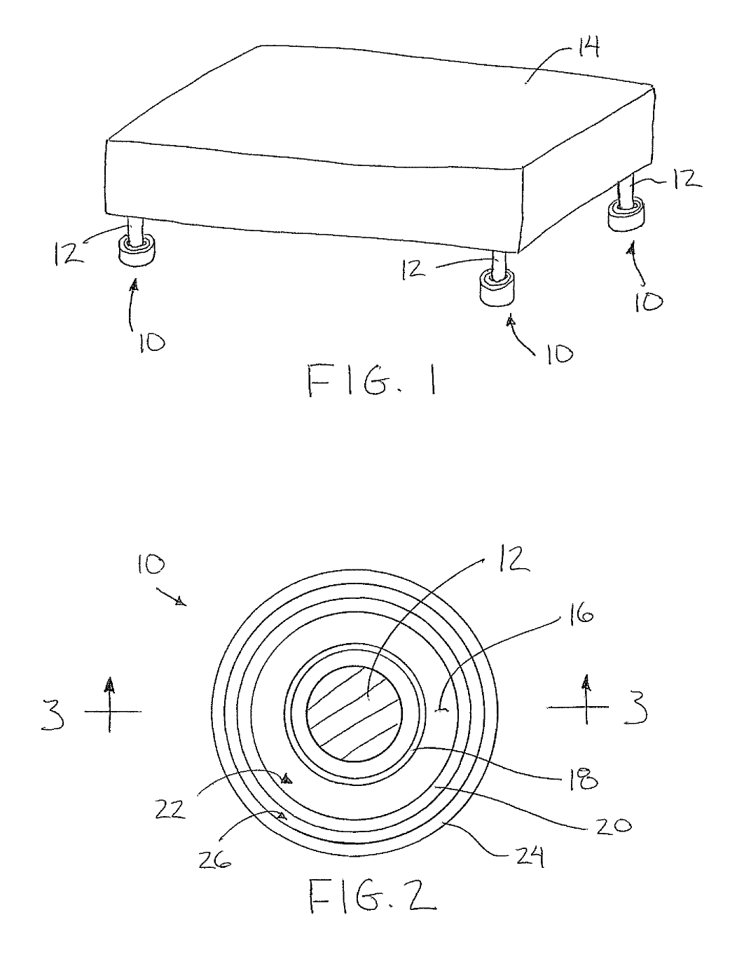

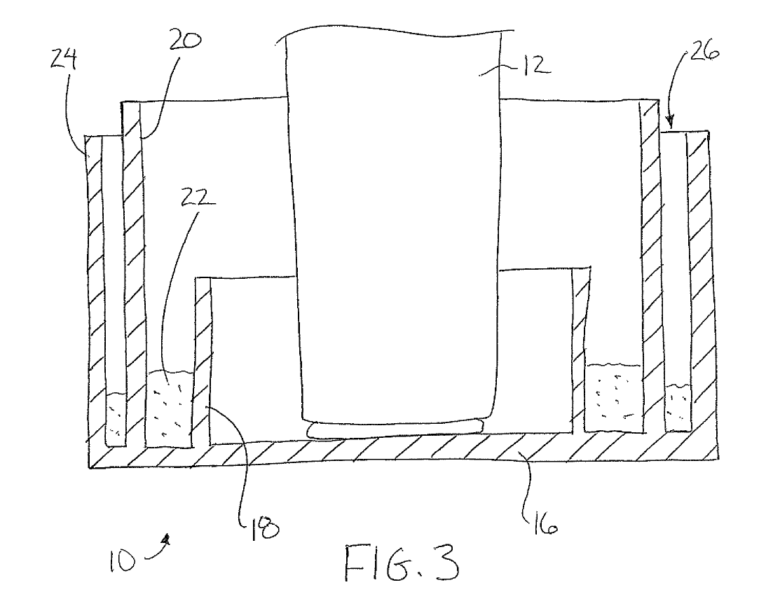

In the drawings like characters of reference indicate corresponding parts in the different figures.

### DETAILED DESCRIPTION

Referring to the accompanying figures there is illustrated a protective coaster device generally indicated by reference numeral 10. The device 10 is particularly suited for use in protecting furniture from crawling insects by using a plurality of the devices 10, with each device supporting a respective furniture leg 12 of the furniture 14, for example a bed thereon.

The device 10 comprises a base member 16 which is flat and circular for being supported directly on the floor or ground. The base member is rigid and suited for structurally supporting the furniture leg on a central area thereof which may be in the order of two to three inches in diameter for example.

A first annular wall 18 is joined to the base member 16 about the central area thereof to full surround the central area. The first annular wall is generally cylindrical in shape extending vertically upward from the base member to an upper peripheral rim which is generally circular an in a horizontal plane. The annular wall typically has a diameter in the range of two to three inches so as to be well suited for receiving common furniture leg through a central opening defined by the upper rim to be received and supported on the central area of the base member 16. In the illustrated embodiment the height of the first annular wall 18 is generally less than the diameter thereof so as to be approximately two inches in height from the base member for example.

A second annular wall 20 is also joined to the base member having a diameter which is greater than the first annular wall so as to fully surround the first annular wall spaced radially outward therefrom. The second annular wall is also cylindrical in shape so as to extend vertically upward from the base member to an upper peripheral rim thereof which is in a horizontal plane spaced above the top end of the first annular wall. In the illustrated embodiment the second annular wall has a height corresponding to approximately twice the height of the first annular wall so as to have a height of approximately four inches for example. The second annular wall is spaced outwardly from the first annular wall evenly in all directions such that the first and second annular walls are circular and concentric with one another about the central area of the base member. The first and second annular walls form a U-shaped trough with a base member such that the resulting annular space between the first and second annular walls is suitable for containing an insect barrier fluid 22 therein. A suitable fluid 22 may comprise water or mineral oil for example which is suitable to prevent passage of bed bugs thereacross. The radial dimension of the annular space between the first and second annular walls may be in the order of one inch.

The device 10 further comprises a third annular wall 24 joined about the periphery of the base member so as to be generally cylindrical in shape and concentric with the first and second annular walls. The third annular wall is greater in diameter than the second annular wall so as to be spaced radially outward therefrom. The third annular wall also extends vertically upward from the base member to an upper peripheral rim having an overall height from the base member which is less than the second annular wall by approximately ¼ of an inch.

A narrow annular crevice 26 is defined between the second and third annular walls which has a narrow radial dimension, for example less than one half inch or near half a centimetre in the illustrated embodiment. The resulting cross section of the annular crevice 26 is elongate in a vertical direction between the base member and an open top end of the crevice. The open top end remains open for unrestricted access by pesticide tools which are suitable for crevice treatment.

The radial dimension and height of the annular crevice between the second and third annular walls is suitable such that the annular crevice meets the definition of a crack or crevice as determined by regulatory bodies such as the Pesticide Management Review Agency for being in accordance with cracks and crevices as defined on pesticide labels. The radial dimension of the crevice is large enough that insects, for example bed bugs cannot bridge the gap from the second annular wall to the third annular wall however the dimension is small enough that children and pets cannot effectively access the inner surfaces of the annular crevice.

The first, second and third annular walls are all formed integrally and seamlessly with the base member such that the body of the device comprising all of the walls thereof is integral and seamless in construction comprising a single continuous piece of like material throughout. The material forming the body of the device is rigid to structurally support the furniture leg thereon without deformation and so as to be tamper resistant and resist deformation from tampering by children and pets and the like.

In use, a user positions one of the protective coaster devices beneath each furniture leg of a piece of furniture such that the furniture leg is supported on the central area and surrounded by the first annular wall. An insect liquid barrier is provided in the annular space between the first and second annular walls. A pesticide rated for use in cracks and crevices is applied into the annular crevice between the second and third annular walls in accordance with the application requirements for a pesticide rated for use in cracks and crevices.

The device 10 is well suited for maintaining a mattress free of bed bugs once it has be sterilised. Sterilising a mattress to rid it of bed bugs can be accomplished by heating the bed in a chamber to a minimum of 122 degrees Fahrenheit to kill all the bed bugs. The legs of the bed are then each placed on a protective device 10.

As described above, the device may generally comprise 3 round pans of unequal size glued together one inside the other forming a single dish with 2 moats. The inside pan is about 2 inches tall and has a diameter large enough to accommodate most bed legs. The second pan has a diameter large enough to make a space between the first and second pans of a size large enough to prevent a bed bug from crossing it if it were filled with mineral oil or water—about 1 inch. The third and largest pan has a diameter large enough to prevent a bed bug from jumping or spanning the distance between the second and third pan but small enough to prevent humans or animals from touching the bottom of the dish, and is slightly shorter than the second dish to ensure the bed bug does not notice the mineral oil in the adjoining moat. The height of the second and third dish are taller than the first dish to decrease the likelihood that a person or animal could touch the bottom of the outside moat but not so tall that they touch the bed. This space could be considered a “crack or crevice” which is language that pesticide labels often contain. The designation of “crevice” allows use of pesticides that normally would not be on label for beds.

The complete construction must be of sufficient strength to prevent deformation caused by tenants deliberately trying to gain access to the bottom of the space between the second and third dish. One example might be metal construction.

The space between the second and third pan is treated with effective pesticides that are on label for bed bugs (such as pyrethroid dusts suitable for cracks and crevices). Therefore when a bed bug approaches the bed it must cross this residual pesticide line but is prevented from gaining access to the bed by the inside water or mineral oil moat. The bug must then go back down into the moat between the second and third dish and receive a second dose of pesticide.

The walls of the crevice are preferably coated or formed with a climbable surface to allow the bugs ready access to the pesticide. After some testing, it has been formed that bed bugs confronted with a slippery edge will be dissuaded from entering. Typical behaviour when confronted with a slippery edge pitfall trap is a straddling of the edge with a great reluctance to let go of the edge. A secondary experiment showed that bed bugs, when confronted with a similar pitfall trap made of a rough, easily climbable surface will readily enter the space. Of course they can easily escape but, given the context of the present invention, the bug will receive a dose of a crack and crevice rated insecticide in the process.

Another option would be to place heat tape on the bottom of the outside moat at a temperature of 122 degrees Fahrenheit. The outside wall would require insulation to avoid dissuading the bed bug from climbing but, given that heat is a secondary attractant to bed bugs, would attract the bed bug and then kill it after it fell into the trap. This would be a chemical free method of killing bed bugs.

When this device is placed under the bed legs of a heat sterilized bed the bugs in the baseboards and furniture are prevented from accessing the bed by the mineral oil moat in a fool proof manner and forced to travel through more effective pesticides on label only for cracks and crevices. If there are no bugs on the bed and the other bugs in the room can not access a blood meal then the egg laying stops which is step one for eradication. This is a very important victory in an age where bed bugs can cross many common residual pesticides on label for bed bugs and still feed and lay eggs. The result is that the remaining bugs in the room continually seek a blood meal and continue gaining more exposure to the pesticides in the room leading to their eventual elimination.

Though this trap functions poorly as a monitoring device the advantage of this device would be that bugs that enter the device would be subjected to more effective pesticides only on label for cracks and crevices and that humans and animals would have no access to the bugs creating a greater safety factor. This device is also far superior to existing traps in that dust, debris, and tenant behaviour cannot easily compromise the isolation of the bed.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A protective coaster device for supporting a furniture leg of an article of furniture thereon, the device comprising:
a body comprising a base member, a first annular wall and a second annular wall formed integrally with one another;
the base member being arranged to be supported on a floor and support the furniture leg at a central area thereon;
the first annular wall being joined to the base member so as to surround the central area of the base member and to extend upwardly from the base member to an upper peripheral rim surrounding a central opening arranged to receive the furniture leg therethrough;
the second annular wall being joined to the base member so as to surround the first annular wall and to extend upwardly from the base member to an upper peripheral rim;
the second annular wall being spaced outwardly from the first annular wall to define an annular space having an open top end between the first and second annular walls arranged to contain an insect barrier fluid therein; and
the integral body further comprising an annular crevice formed therein so as to surround the second annular wall, the annular crevice being arranged to receive a pesticide for cracks and crevices therein.

2. The device according to claim 1 wherein the annular crevice is arranged to receive a pesticide rated for cracks and crevices in accordance with pesticide labelling.

3. The device according to claim 1 wherein the annular crevice is arranged to receive a pesticide rated for cracks and crevices as defined by pesticide regulatory bodies.

4. The device according to claim 1 wherein the annular crevice is vertically oriented between the base member and a top opening.

5. The device according to claim 1 wherein the annular crevice is elongate in a vertical direction in cross section between the base member and a top opening.

6. The device according to claim 1 wherein an inner surface of the annular crevice is formed of a material having a high coefficient of friction so as to be arranged to allow climbing insects to readily climb thereon.

7. The device according to claim 1 wherein the annular crevice extends downwardly from a top opening, the top opening having a radial dimension which is less than ½ an inch.

8. The device according to claim 1 wherein the body comprises a third annular wall joined to the base member so as to surround the second annular wall and to extend upwardly from the base member to an upper peripheral rim, the annular crevice being defined between the second and third annular walls.

9. The device according to claim 8 wherein the second annular wall is taller in height from the base member than the third annular wall.

10. The device according to claim 8 wherein a height of the second and third annular walls from the base member is at least 3 inches.

11. The device according to claim 8 wherein a height of the second and third annular walls from the base member is approximately 4 inches.

12. The device according to claim 8 wherein the first, second and third annular walls are generally cylindrical in shape and are concentric with one another.

13. The device according to claim 1 wherein the first annular wall is shorter than the second annular wall.

14. The device according to claim 13 wherein the second annular wall is approximately twice a height of the first annular wall.

15. The device according to claim 1 in combination with an insect barrier fluid in the annular space between the first and second annular walls.

16. The device according to claim 1 in combination with a pesticide in the annular crevice which is rated for cracks and crevices.

17. A protective coaster device for supporting a furniture leg of an article of furniture thereon, the device comprising:
a body comprising a base member, a first annular wall, a second annular wall and a third annular formed integrally and seamlessly with one another;
the base member being arranged to be supported on a floor and support the furniture leg at a central area thereon;
the first annular wall being joined to the base member so as to surround the central area of the base member and to extend upwardly from the base member to an upper peripheral rim surrounding a central opening arranged to receive the furniture leg therethrough;
the second annular wall being joined to the base member so as to surround the first annular wall and to extend upwardly from the base member to an upper peripheral rim;
the second annular wall being spaced outwardly from the first annular wall to define an annular space having an open top end between the first and second annular walls arranged to contain an insect barrier fluid therein; and
the third annular wall being joined to the base member so as to surround the second annular wall and to extend upwardly from the base member to an upper peripheral rim;
the third annular wall being spaced outwardly form the first annular wall to define an annular crevice having an open top end between the second and third annular walls;
the second and third annular walls being substantially vertical such that the annular crevice is elongate in a vertical direction between the base member and the open top end;
the open top end of the annular crevice having a radial dimension which is less than ½ an inch such that the annular crevice is configured to receive a pesticide rated for cracks and crevices as defined by pesticide regulatory bodies and in accordance with pesticide labelling;
an insect barrier fluid received in the annular space between the first and second annular walls; and
a pesticide in the annular crevice between the second and third annular walls which is rated for cracks and crevices.

18. A method of isolating an article of furniture comprising a plurality of furniture legs from crawling insects, the method comprising:
providing a protective coaster device associated with each furniture leg, each protective coaster device comprising:
a body comprising a base member, a first annular wall and a second annular wall formed integrally with one another;
the first annular wall being joined to the base member so as to surround a central area of the base member and to extend upwardly from the base member to an upper peripheral rim surrounding a central opening arranged to receive the furniture leg therethrough;
the second annular wall being joined to the base member so as to surround the first annular wall and to extend upwardly from the base member to an upper peripheral rim;
the second annular wall being spaced outwardly from the first annular wall to define an annular space having an open top end between the first and second annular walls; and
the integral body further comprising an annular crevice formed therein so as to surround the second annular wall;
supporting the base member of each coaster device on the floor and supporting the associated furniture leg at the central area on the base member;
providing an insect barrier fluid in the annular space of each coaster device between the first and second annular walls; and
providing a pesticide rated for cracks and crevices in the annular crevice surrounding the second annular wall of each coaster device.

19. The method according to claim 18 including providing each coaster device with a third annular wall joined to the base member so as to surround the second annular wall and so as to extend upwardly from the base member to an upper peripheral rim such that the annular crevice is defined between the second and third annular walls.

20. The method according to claim 19 including supporting both the second and third annular walls of each coaster device in a vertical orientation having a substantially identical height such that the annular crevices are elongate in a vertical direction between the base member and the open top end of the annular crevice.
